(19) United States
(12) Patent Application Publication
(10) Pub. No.: US 2020/0382365 A1
(43) Pub. Date: Dec. 3, 2020

(54) UPDATING SOFTWARE IN CLOUD GATEWAYS

(71) Applicant: SIEMENS AKTIENGESELLSCHAFT, München (DE)

(72) Inventor: Amit Verma, Taufkirchen (DE)

(21) Appl. No.: 16/466,639

(22) PCT Filed: Nov. 6, 2017
(86) PCT No.: PCT/EP2017/078343

§ 371 Date: Jun. 4, 2019

(30) Foreign Application Priority Data
Dec. 5, 2016 (EP) 16202223.0

(51) Int. Cl. H04L 12/24; G06F 8/65; H04L 29/08; H04L 12/26

(52) U.S. Cl. CPC H04L 41/082; H04L 43/0817; H04L 67/34; G06F 8/65

(57) ABSTRACT

A method and a computer program having an implementation of the method for updating software in a plurality of cloud gateways, by which automation solutions are connected to the cloud, are provided. A ranking of the cloud gateways according to a hazard potential of the connected automation solutions is determined. A success of the update occurring in the preceding step is checked before the updating is continued. The updating is continued with a cloud gateway or a group of cloud gateways having the next higher hazard potential if, in the step for checking the success of the preceding update, it was determined that the update occurred without errors. The checking of the success of the preceding update and the continuing of the updating are repeated until the update has also occurred for the cloud gateway or a group of cloud gateways having the highest hazard potential.

This application is the National Stage of International Application No. PCT/EP2017/078343, filed Nov. 6, 2017, which claims the benefit of European Patent Application No. 16202223.0, filed Dec. 5, 2016. The entire contents of these documents are hereby incorporated herein by reference.

### BACKGROUND

The present embodiments relate to software updating in cloud gateways.

The use of cloud services is becoming more and more common as well as for industrial Internet of (IIoT). In this technical context, for example, sensors and actuators, automation devices (e.g., memory-programmable controls, decentralized field devices and the like), or entire automation systems (e.g., in the form of a network of the aforementioned automation devices and connected sensors and actuators) are connected to the cloud via cloud gateways (e.g., gateways). Such a gateway is, for example, a module or device installed at the site of the respective automation solution that forms the interface between the functional units pertaining to the automation solution (e.g., sensors, actuators, automation devices, machines, aggregates and installations or installation parts of the automation solution, etc.) or a group of such functional units and the cloud. The gateway gathers the data from functional units of the aforementioned kind and forwards the data to a respective cloud platform with automation functions/automation services. Optional preprocessing of the data and/or encryption of the data may take place in connection with such forwarding. The gateway may also be used to form a closed control loop if the control function is implemented as a service in the cloud and, in the context of control, processes data originating from the automation solution, and within the cloud, specific data is generated as a controlled variable or controlled variables for a functional unit of the automation solution.

Each gateway acts an independent interface between a respective automation solution for controlling and/or monitoring a technical process or a group of individual functional units of an automation solution and the cloud. In order to use IIoT services, an automation solution is connected to the cloud via at least one gateway or a group of gateways. With a plurality of automation solutions connected to the cloud, a plurality of gateways also results accordingly. For the sake of linguistic simplification, but without renouncing a more general universality, the following description is continued based on exactly one gateway for each automation solution, which in a sense connects “its” respective automation solution to the cloud.

A device functioning as a gateway in the above-mentioned sense is connected to the Internet in a suitable manner and, via the Internet, connection takes place in a manner that is basically known per se to the respective cloud platform and IIoT services provided there. However, the connection to the Internet entails a non-insignificant security risk. This is not limited to only the gateway itself but extends to the respective automation solution because in the event of failure or malfunction of the gateway, the automation solution is also directly affected. The vulnerability of a gateway via the Internet may therefore also be used to attack the respective automation solution connected to the gateway. For this reason, functional or security updates and the like (e.g., a software update or update) of the system software of the gateway are of immense importance.

Updates of the aforementioned type also themselves pose a fundamental risk to the proper functioning of a gateway. In the case of a faulty update or a failed update, the proper functioning of the gateway is often no longer given. As a result, this also affects the function of the connected automation solution or even calls into question the function of the connected automation solution completely. Malfunctions of the gateway due to a faulty or failed update may result in data transmitted via the gateway no longer being available or no longer being available in due form. This or other errors resulting from an erroneous or failed update may result in malfunctions in the automation solution or undefined behavior of the automation solution with potentially disastrous results.

At present, a software update for a cloud gateway or a plurality of cloud gateways does not take into account the type of devices connected and connected to the cloud via the respective cloud gateway. Thus, in the case of a software update, it is not possible to take into account the risks that may arise if a software update fails.

### SUMMARY AND DESCRIPTION

The scope of the present invention is defined solely by the appended claims and is not affected to any degree by the statements within this summary.

The present embodiments may obviate one or more of the drawbacks or limitations in the related art. For example, a software update that takes into account the risks that may arise if a software update fails is provided.

A method for software updating (e.g., update) of a plurality of gateways, where automation solutions are connected to the cloud by the gateways, is provided.

In a first act, a ranking of gateways corresponding to a potential risk of each automation solution connected to the gateways is determined.

In a second act, the gateway or a group of gateways with a lowest potential risk is updated.

In a third act, a success of the update that has taken place in the preceding second act is checked.

In a fourth act, updating is continued with a gateway or a group of gateways with the next highest potential risk if it was determined in the third act for verifying the success of the previous update that the update took place without any errors, or updating is aborted if it was determined in the third act for verifying the success of the preceding update that the update did not take place without any errors.

If it was determined in the third act for verifying the success of the previous update that the update took place without any errors, and then, the fourth act was performed accordingly, the third act and the fourth act are repeated thereafter; updating is continued until updating has also taken place for the gateway or a group of gateways with the highest potential risk or updating has been aborted in the meantime due to updating not taking place without any errors.

The advantage of the method of one or more of the present embodiments is that the update commences according to the determined ranking of the gateways with the gateway or a group of gateways with the least potential risk. If errors occur, this does not affect gateways with a higher potential risk and, above all, corresponding automation solutions. If the method is aborted because of a failed update, the cause of the error may be determined and resolved, and the method may be re-executed at a later time until the update has finally taken place successfully for all the gateways, including the gateway or a group of gateways with the highest potential risk.

The ranking of the gateways may be based on the potential risk to be determined for each connected automation solution. In one embodiment of the method, the potential risk of functional units (e.g., assets) belonging to the individual automation solutions is considered to determine the potential risk of the individual automation solutions. Accordingly, when determining a ranking of the gateways corresponding to a potential risk for each automation solution connected to the gateways in one embodiment of the method, a potential risk of the functional units (e.g., assets) belonging to an automation solution is taken into account. This is determined based on predetermined or predeterminable data of a database maintained in the cloud (e.g., asset metadatabase). Such a database enables a dynamic adaptation of the data taken into account in determining the potential risk. The adaptation may, for example, be performed by an operator of a respective automation solution and/or the operator of the cloud platform.

In a particular embodiment of the method based on such a database for the determination of the potential risk, the data in the database includes an estimated value of the potential risk of the respective functional unit (e.g., asset). In this way, for example, when commissioning an automation solution, a value depending on the respective automation solution for the potential risk may be specified because, for example, a temperature controller may perform both relatively non-critical functions as well as safety-related functions. The possibility of a programmer, a commissioning engineer, or an operator of the respective automation solution entering an estimated value thus makes it possible to take into account the actual conditions of the respective automation solution in a particularly simple manner.

In a further embodiment of the method, an operating state of the functional units (e.g., assets) pertaining to an automation solution is considered alternatively or additionally when determining a ranking of the gateways corresponding to a potential risk of each automation solution connected to the gateways. In this way, for example, the potential risk of a gateway with one or at least one potentially extremely critical automation solution may decrease if, for example, the one or at least one potentially extremely critical automation solution is not in operation. The consideration of the operating state allows an adaptation of the method not only to the static conditions expressed by a categorization of the automation solutions and the functional units included therein, but also to the current conditions (e.g., to an automation solution state (an automation solution or a functional unit included therein is running or is not running or is not in operation for other reasons—maintenance or the like)).

Data on the operating state of the functional units is made available in a further database (e.g., asset state database) maintained in the cloud and is then available in the cloud for determining the ranking of the gateways as well as the data in the asset metadatabase.

In a further embodiment of the method, an execution takes place, by a ranking service (e.g., criticality ranking service) and by an update service (e.g., software update roll-out service), each in the cloud. Using the ranking service (e.g., criticality ranking service), the ranking of the gateways is determined. Using the update service (e.g., software update roll-out service), the updating of a gateway or a group of gateways, the checking of the success of an update, as well as the aborting of the update or the continuation of the update depends on the success of the previous update. As a result, the essential functions of the method provided by one or more of the present embodiments are separated from each other. This facilitates the implementation of the method in software and the maintenance of a resulting computer program.

As another example, a processing unit or the like acting as a node computer in the cloud is configured to carry out the method described here and below. The present embodiments may be implemented in software. One or more of the present embodiments are thus also a computer program with program code instructions executable by a computer in the form of the processing unit and a storage medium with such a computer program (e.g., a computer program product with program code resources), and a processing unit in the memory of which such a computer program is or may be loaded as a way of carrying out the method and corresponding embodiments.

For a further description, in order to avoid unnecessary repetition, it is understood that features and details described in connection with the method of software updating of a plurality of cloud gateways and any embodiments are also applicable in connection with and with regard to the processing unit intended and configured for carrying out the method and vice versa, so that the processing unit may also be developed in accordance with individual or multiple method features, in that the processing unit is configured for execution of such features.

The method described hereinafter for software updating of a plurality of cloud gateways is implemented for automatic execution in the form of a computer program or in the form of a distributed computer program. The computer program is intended for execution, for example, by a processing unit functioning as a node computer in the cloud. If method acts or method act sequences are described hereinafter, this refers to actions that take place automatically and without the intervention of a user due to the computer program or under the control of the computer program. At a minimum, any use of the term “automatic” provides that the action concerned is due to the computer program or under the control of the computer program.

Instead of an implementation of the method proposed here in software, an implementation in firmware or in firmware and software, or in firmware and hardware may also be provided. Therefore, the term software or the term computer program also includes other implementation options (e.g., an implementation in firmware, or in firmware and software, or in firmware and hardware).

Exemplary embodiments are described in more detail with reference to the diagram. Corresponding objects or elements are identified by the same reference characters in all the figures.

The exemplary embodiments are not to be understood as a limitation of the invention. Rather, additions and modifications are possible in the context of the present disclosure (e.g., those that may be inferred by the person skilled in the art by combining or modifying individual features or method acts described in conjunction with the general or specific part of the description and contained in the claims and/or the diagram with regard to the solution of the task and lead to a new subject matter or to new method acts and/or method act sequences by combinable features).

### BRIEF DESCRIPTION OF THE DRAWINGS

FIG. 1 shows cloud gateways connected to a cloud and automation solutions connected to the cloud and a cloud platform with maintained IIoT services;

FIG. 2 shows a simplified schematic representation as a basis for an explanation of one embodiment of a method for software updating of a group of cloud gateways; and

FIG. 3 shows a schematically simplified representation of one embodiment of a method proposed in the form of a flow chart as a basis for a computer program with an implementation of the method.

### DETAILED DESCRIPTION

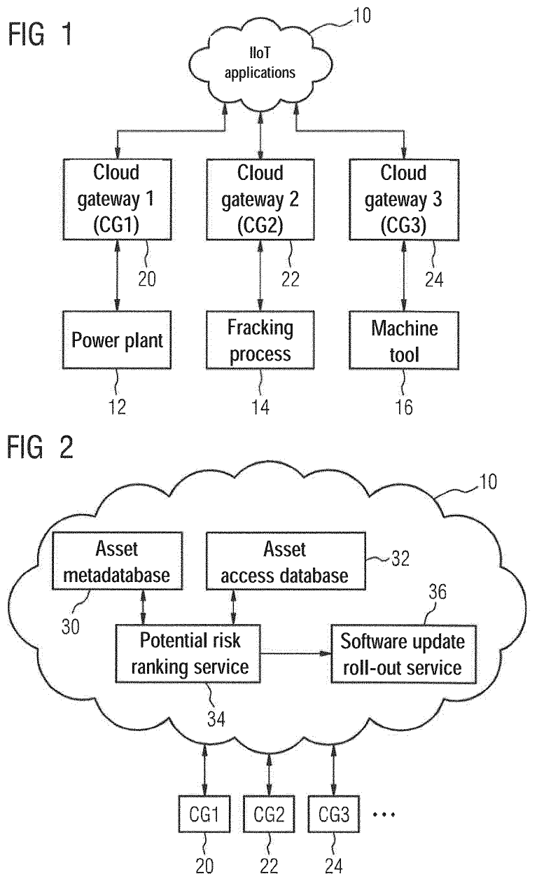

The illustration in FIG. 1 shows the cloud 10 with IIoT services stored therein and connected automation solutions 12, 14, 16 for controlling and/or monitoring a technical process. The automation solutions 12, 14, 16 may be different critical automation solutions 12, 14, 16. Schematically simplified examples are shown in FIG. 1. Accordingly, a first automation solution 12 is an automation solution for a power plant with a critical turbine, a second automation solution 14 is an automation solution for a fracking process for oil and gas production (e.g., fracking process), and a third automation solution 16 is an automation solution for a manufacturing process with, for example, a CNC machine (machine tools). Each automation solution 12, 14, 16 is connected to the cloud 10 via at least one individual cloud gateway 20, 22, 24.

The updating of the system software of devices acting as cloud gateways 20, 22, 24 (e.g., gateways 20, 22, 24) took place without consideration of the respective connected automation solutions 12, 14, 16. It is easy to imagine that in the event of an error during such an update, the effects in a manufacturing process (e.g., third automation solution 16) are generally less critical than the effects in a power plant with a critical turbine (e.g., first automation solution 12). If, as in the past, in the event of the availability of an update for gateways 20, 22, 24, the update is simultaneously imported to all gateways 20, 22, 244 connected to the cloud 10 or to a group of gateways 20, 22, 24 connected to the cloud 10, in the event of an error, there is the threat of a malfunction not only in the less critical third automation solution 16, but also in the particularly critical first automation solution 12.

This is avoided using the approach presented here, in which, when updating individual gateways 20, 22, 24 in a group of gateways 20, 22, 24, a ranking of the respective automation solutions 12-14 connected to the individual gateways 20, 22, 24 is determined and taken into account. The determined ranking expresses the potential risk (e.g., Criticality) associated with a failure or a malfunction of the respective automation solution 12, 14, 16. The ranking criterion that determines the ranking is referred to as the potential risk (e.g., Criticality) hereinafter.

For the determination of the potential risk, use is made of the fact that the functional units connected to a gateway 20, 22, 24 in the context of an automation solution 12, 14, 16 and hereinafter also sometimes referred to as assets (e.g., functional units of the type mentioned at the start), each have a unique identifier (e.g., asset ID; A1, A2, A3, etc.). Similarly, the gateways 20-22 have a unique identifier (e.g., gateway ID; G1, G2, G3, etc.). In a database 30 acting as an asset metadatabase (FIG. 2), data concerning each functional unit (e.g., asset) connected to the cloud 10 by a gateway 20, 22, 24 is stored in the cloud 10. This data includes a coding of a potential risk (e.g., Criticality) associated with the respective functional unit (e.g., asset) where, for example, this is specified as an estimated value by the operator of the respective functional unit or the developer of the automation solution 12, 14, 16 to which the functional unit belongs. Optionally, the data also includes a coding of the function of the respective functional unit, thus making it possible to automatically detect, for example, whether a functional unit acts as a sensor, actuator, controller, etc. The data optionally includes information about the manufacturer, the model, and/or a current software version of the functional unit and the like. This data (e.g., metadata) is assigned, for example, during the configuration of the individual functional units, during connection of the individual function units to the respective gateway 20, 22, 24, or during the commissioning of the automation solution 12, 14, 16, and stored in a retrievable manner under the respective asset ID in the database 30 in the cloud 10.

A basically optional further database 32 acting as an asset state database (e.g., asset state DB) (FIG. 2) includes coding of an operating state of the respective functional unit under the respective asset ID. Operating states such as “running”, “waiting”, “under maintenance”, etc. are states detected in this respect, for example.

Based on the data in the database 30 or optionally based on the data in the database 30 and the further database 32, the potential risk of the individual automation solutions 12-16 is evaluated, and a ranking of the gateways 20, 22, 24 is determined. For this purpose, the representation in FIG. 2 shows the referenced databases 30, 32, the gateways 20, 22, 24, by which the automation solutions 12, 14, 16 (FIG. 1) are connected to the cloud 10, as well as a ranking service 34 (e.g., Criticality Ranking Service) and an update service 36 (e.g., Software Update Roll-out Service).

The ranking of the gateways 20, 22, 24 is determined by the ranking service 34 maintained in the cloud 10. The ranking service 34 accesses the database 30 (e.g., asset metadata DB) or optionally the database 30 (e.g., asset metadata DB) and the further database 32 (e.g., asset state DB) and determines the potential risk of the respective automation solution 12, 14, 16 for all the connected gateways 20, 22, 24 for the functional units (e.g., assets) connected in turn thereto. For example, the potential risk (e.g., Criticality Score) for each gateway 20, 22, 24 of each individual functional unit (e.g., asset) connected thereto is initially determined as a function of at least one item of data or of several items of data stored in the database 30 (e.g., asset metadata DB) for the respective functional unit:

Criticality Score(A1)=f(d1 . . . dn),

where d1 to do stands for data available in the database 30 (e.g., asset metadata DB), for example, for the estimated value for the potential risk (e.g., vendor criticality estimate) associated with a functional unit (e.g., asset). In a further act, the potential risk of the automation solution 12-16 connected to the respective gateway 20, 22, 24 is determined from the thus determined potential risk of the individual functional units (e.g., assets) connected to a gateway 20, 22, 24. For determining the potential risk of each gateway 20, 22, 24 (e.g., CG1, CG2, CG3, . . . ), for example, the formation of a sum of the potential risks determined for the functional units (e.g., assets) connected thereto is considered:

Criticality Score(CGx)=Criticality Score(A1(CGx))+Criticality Score(A2(CGx))+ . . .

In this way, an automatically processable (e.g., numerical) coding of the potential risk of each individual gateway 20, 22, 24 is made available. Based on this, a ranking of the gateways 20, 22, 24 is determined. Based on this ranking, the gateways 20, 22, 24 are finally updated by the update service 36 in accordance with the determined ranking, such that the update first takes place at the gateway 20, 22, 24 with the lowest determined potential risk and last at the gateway 20, 22, 24 with the highest determined potential risk. For gateways 20, 22, 24 with a potential risk between the lowest determined potential risk and the highest determined potential risk, updating takes place in the order of the determined potential risks.

Optionally, a grouping may take place when determining the ranking of the gateways 20, 22, 24, for example, such that gateways 20, 22, 24 with a particularly low potential risk are assigned to a first group, gateways 20, 22, 24 with an average potential risk are assigned to a second group, and gateways 20, 22, 24 with a particularly high potential risk are assigned to a third group. Updating first takes place by the update service 36 and simultaneously or quasi-simultaneously for the gateways 20, 22, 24 of the first group, thereafter and simultaneously or quasi-simultaneously for the gateways 20, 22, 24 of the second group, and thereafter and simultaneously or quasi-simultaneously for the gateways 20, 22, 24 of the third group.

The function of the update service 36 is not limited to downloading and importing an update to a gateway 20, 22, 24 or the gateways 20, 22, 24, but also includes an inspection of the update history. After an update for a gateway 20, 22, 24 or a group of gateways 20, 22, 24, the update is only continued according to the determined ranking sequence if the update was successful. This provides that in the event of a failed or erroneous update, only one gateway 20, 22, 24 or gateways 20, 22, 24 with a low potential risk and a corresponding position in the ranking is or are affected. Gateways 20, 22, 24 with a higher potential risk are not affected, and the automation solutions 12-16 connected to the cloud 10 thereby continue to be executed.

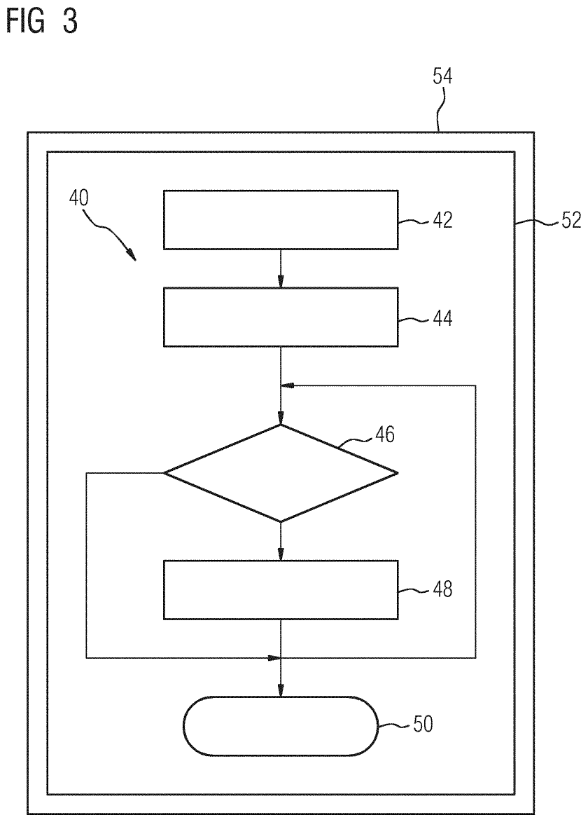

In detail, the method of one or more of the present embodiments for software updating (e.g., update) of cloud gateways (e.g., gateways) 20, 22, 24, where automation solutions 12, 14, 16 are connected to the cloud 10 via the gateways 20, 22, 24 (e.g., to a cloud platform maintained in the cloud 10, includes the following acts shown in the representation in FIG. 3 as an example of an implementation of the method in software (e.g., computer program 40) in the form of a flow chart.

The ranking of the gateways 20, 22, 24 is first determined in a first act 42 corresponding to a potential risk of each automation solution 12-16 connected to each gateway 20, 22, 24. This is done by the ranking service 34 maintained in the cloud 10 (e.g., belonging to the respective cloud platform). The function of the ranking service 34 includes, for example, the functions described above.

In a second act 44, an update of a gateway 20, 22, 24 or a group of gateways 20, 22, 24 with the lowest potential risk is attempted with the ranking of the gateways 20, 22, 24 fixed in the first act 42.

In a third act 46 (e.g., in the first embodiment of the third act 46), the success of the update carried out in the preceding second act 44 is checked. This is done, for example, by automatic checking of log files and/or lifebeat monitoring of each gateway 20, 22, 24 affected by the update. Depending on the result of the check in the third act 46, the update is aborted or branched to a fourth act 48. Updating is aborted (e.g., branching to the program end 50) if, during the check in the third act 46, it has emerged that the preceding update (second act 44) did not occur in an error-free manner. Updating is continued with the fourth act 48 if it has emerged in the check in the third act 46 that the preceding update (e.g., second act 44) occurred without errors.

In the fourth act 48, updating with a gateway 20, 22, 24 or a group of gateways 20, 22, 24 is continued with the next highest potential risk compared to the preceding update.

Thereafter, the program branches back to the third act 46, and in each case, it is checked whether the preceding update (e.g., act 48) was successful or not until updating has also taken place for the gateway 20, 22, 24 or a group of gateways 20, 22, 24 with the highest potential risk.

When the update for the gateway 20, 22, 24 or a group of gateways 20, 22, 24 with the highest potential risk has taken place, the method ends (e.g., program end 50) and the software update for the gateways 20, 22, 24 is completed. If it is determined during the method (e.g., third step 46) that an update was not successful at a gateway 20, 22, 24 or a group of gateways 20, 22, 24, the method is aborted immediately. The functional capability of each gateway 20, 22, 24 that is not affected by the update or updates made up to this point is still given. Because the updates are carried out in accordance with the previously determined ranking and thus according to the potential risk assigned to each gateway 20, 22, 24, it is provided that gateways 20, 22, 24 with a high potential risk are only updated if the update has already been successfully carried out for at least one gateway 20, 22, 24 with a lower potential risk; accordingly, it may be assumed that all further updates may also be carried out successfully.

As shown schematically in simplified form in FIG. 3, the computer program 40 is loaded with an implementation of the method and, possibly, individual or multiple embodiments into a memory 52 of a processing unit 54 (e.g., a processing unit 54 functioning as a computer node in the cloud 10), and is executed during operation of the processing unit 54 for software updating (e.g., update) of a plurality of cloud gateways 20, 22, 24.

Hitherto, it was assumed that each automation solution 12-16 was connected to the cloud 10 via precisely one individual or at least one individual cloud gateway 20, 22, 24. With the approach proposed, a situation may also be practicable in which a plurality of automation solutions 12-16 are connected to the cloud 10 via a cloud gateway 20. Then, for example, it is possible to determine the potential risks of the individual automation solutions 12-16 connected to the cloud 10 for the relevant gateway 20, 22, 24 and to consider only the highest potential risk identified when determining the ranking of the respective gateway 20, 22, 24.

Although the invention was illustrated and described in more detail by the exemplary embodiments, the invention is not limited by the disclosed example or examples, and other variations may be derived therefrom by a person skilled in the art without departing from the scope of the invention.

Individual aspects of the description presented may be summarized briefly as follows: A method for software updating (e.g., update) of a plurality of cloud gateways 20, 22, 24 is specified, where automation solutions 12-16 are connected to the cloud 10 via the cloud gateways 20, 22, 24. The method is based on an initial determination of a ranking of the cloud gateways 20, 22, 24 corresponding to a potential risk of the connected automation solutions 12, 14, 16. The sequence of updating is obtained from the ranking. Thereafter, updating begins with the cloud gateway 20, 22, 24 or a group of cloud gateways 20, 22, 24 with the lowest potential risk. Then the success of the update that has taken place in the previous act is checked before updating is continued. If it was determined in the act for checking the success of the previous update that the update took place without errors, updating with a cloud gateway 20, 22, 24 or a group of cloud gateways 20, 22, 24 with the next highest potential risk is continued. If it was determined in the act for checking the success of the previous update that the update was not completed without errors, updating will be aborted altogether. Otherwise, the acts of checking the success of the previous update and continuing the update are repeated until the update has also been completed for the cloud gateway 20, 22, 24 or a group of cloud gateways 20, 22, 24 with the highest potential risk.

The elements and features recited in the appended claims may be combined in different ways to produce new claims that likewise fall within the scope of the present invention. Thus, whereas the dependent claims appended below depend from only a single independent or dependent claim, it is to be understood that these dependent claims may, alternatively, be made to depend in the alternative from any preceding or following claim, whether independent or dependent. Such new combinations are to be understood as forming a part of the present specification.

While the present invention has been described above by reference to various embodiments, it should be understood that many changes and modifications can be made to the described embodiments. It is therefore intended that the foregoing description be regarded as illustrative rather than limiting, and that it be understood that all equivalents and/or combinations of embodiments are intended to be included in this description.

1. A method for software updating of a plurality of cloud gateways via which automation solutions are connected to a cloud, the method comprising:
determining a ranking of the plurality of cloud gateways corresponding to a potential risk of each of the automation solutions connected to each cloud gateway of the plurality of cloud gateways;
updating the cloud gateway or a group of cloud gateways of the plurality of cloud gateways with a lowest potential risk;
checking a success of the updating;
continuing the updating with a cloud gateway or a group of cloud gateways of the plurality of cloud gateways with a next highest potential risk if in the checking of the success of the previous updating, it is determined that the updating completed without errors, or aborting the updating if in the checking of the success of the previous updating, it is determined that the updating was not completed without errors; and
repeating the continuing of the updating and checking the success of the previous updating until the updating has also been completed for the cloud gateway or a group of cloud gateways of the plurality of cloud gateways with a highest potential risk,
wherein determining the ranking of the plurality of cloud gateways corresponding to the potential risk of each of the automation solutions connected to each cloud gateway of the plurality of cloud gateways comprises taking into account a risk potential of functional units pertaining to an automation solution, determining a corresponding potential risk based on predetermined or predefinable data, and storing the corresponding potential risk in a database maintained in the cloud.

2. (canceled)

3. The method of claim 1, wherein the data in the database contains an estimated value with regard to the potential risk of the respective functional unit.

4. The method of claim 3, wherein an operating state of the functional units pertaining to an automation solution is taken into consideration when determining a ranking of the plurality of cloud gateways corresponding to a potential risk of each of the automation solutions connected to the plurality of cloud gateways.

5. The method of claim 4, wherein data regarding the operating state of the functional units is made available in a further database maintained in the cloud.

6. The method of claim 1, wherein determining the ranking of the plurality of cloud gateways comprises determining the ranking of the plurality of cloud gateways by a ranking service in the cloud, and
wherein the updating of the cloud gateway or the group of cloud gateways, the checking of the success of the updating, and the aborting of the updating or the continuing of the updating takes place by an update service in the cloud depending on success of the previous updating.

7. (canceled)

8. A computer program product comprising:
a non-transitory computer-readable storage medium that stores instructions executable by a processor acting as a computer node in a cloud for software updating a plurality of cloud gateways via which automation solutions are connected to the cloud, the instructions comprising:
determining a ranking of the plurality of cloud gateways corresponding to a potential risk of each of the automation solutions connected to each cloud gateway of the plurality of cloud gateways;
updating the cloud gateway or a group of cloud gateways of the plurality of cloud gateways with a lowest potential risk;
checking a success of the previous updating;
continuing the updating with a cloud gateway or a group of cloud gateways of the plurality of cloud gateways with a next highest potential risk if in the checking of the success of the previous updating, it is determined that the updating completed without errors, or aborting the updating if in the checking of the success of the previous updating, it is determined that the updating was not completed without errors; and
repeating the continuing of the updating and checking the success of the previous updating until the updating has also been completed for the cloud gateway or a group of cloud gateways of the plurality of cloud gateways with a highest potential risk,
wherein determining the ranking of the plurality of cloud gateways corresponding to the potential risk of each of the automation solutions connected to each cloud gateway of the plurality of cloud gateways comprises taking into account a risk potential of functional units pertaining to an automation solution, determining a corresponding potential risk based on predetermined or predefinable data, and storing the corresponding potential risk in a database maintained in the cloud.

9. A non-transitory computer-readable storage medium that stores instructions executable by a processor acting as a computer node in a cloud for software updating a plurality of cloud gateways via which automation solutions are connected to the cloud, the instructions comprising:
determining a ranking of the plurality of cloud gateways corresponding to a potential risk of each of the automation solutions connected to each cloud gateway of the plurality of cloud gateways;
updating the cloud gateway or a group of cloud gateways of the plurality of cloud gateways with a lowest potential risk;
checking a success of the previous updating;
continuing the updating with a cloud gateway or a group of cloud gateways of the plurality of cloud gateways with a next highest potential risk if in the checking of the success of the previous updating, it is determined that the updating completed without errors, or aborting the updating if in the checking of the success of the previous updating, it is determined that the updating was not completed without errors; and
repeating the continuing of the updating and checking the success of the previous updating until the updating has also been completed for the cloud gateway or a group of cloud gateways of the plurality of cloud gateways with a highest potential risk,
wherein determining the ranking of the plurality of cloud gateways corresponding to the potential risk of each of the automation solutions connected to each cloud gateway of the plurality of cloud gateways comprises taking into account a risk potential of functional units pertaining to an automation solution, determining a corresponding potential risk based on predetermined or predefinable data, and storing the corresponding potential risk in a database maintained in the cloud.

10. A device for software updating a plurality of cloud gateways via which automation solutions are connected to a cloud, the device comprising:
a processor; and
a memory that stores instructions executable by the processor to software update the plurality of cloud gateways via which automation solutions are connected to the cloud, the software update comprising:
determination of a ranking of the plurality of cloud gateways corresponding to a potential risk of each of the automation solutions connected to each cloud gateway of the plurality of cloud gateways;
update of the cloud gateway or a group of cloud gateways of the plurality of cloud gateways with a lowest potential risk;
check of a success of the previous update;
continuation of the update with a cloud gateway or a group of cloud gateways of the plurality of cloud gateways with a next highest potential risk if in the check of the success of the previous update, it is determined that the update completed without errors, or abortion of the update if in the check of the success of the previous update, it is determined that the update was not completed without errors; and
repetition of the continuation of the update and the check of the success of the previous update until the update has also been completed for the cloud gateway or a group of cloud gateways of the plurality of cloud gateways with a highest potential risk,
wherein the determination of the ranking of the plurality of cloud gateways corresponding to the potential risk of each of the automation solutions connected to each cloud gateway of the plurality of cloud gateways comprises a risk potential of functional units pertaining to an automation solution being taken into account, determination of a corresponding potential risk based on predetermined or predefinable data, and store of the corresponding potential risk in a database maintained in the cloud.

11. The non-transitory computer-readable storage medium of claim 9, wherein the data in the database contains an estimated value with regard to the potential risk of the respective functional unit.

12. The non-transitory computer-readable storage medium of claim 11, wherein an operating state of the functional units pertaining to an automation solution is taken into consideration when determining a ranking of the plurality of cloud gateways corresponding to a potential risk of each of the automation solutions connected to the plurality of cloud gateways.

13. The non-transitory computer-readable storage medium of claim 12, wherein data regarding the operating state of the functional units is made available in a further database maintained in the cloud.

14. The non-transitory computer-readable storage medium of claim 9, wherein determining the ranking of the plurality of cloud gateways comprises determining the ranking of the plurality of cloud gateways by a ranking service in the cloud, and
wherein the updating of the cloud gateway or the group of cloud gateways, the checking of the success of the updating, and the aborting of the updating or the continuing of the updating takes place by an update service in the cloud depending on success of the previous updating.
